(19) United States
(12) Patent Application Publication
(10) Pub. No.: US 2017/0252653 A1
(43) Pub. Date: Sep. 7, 2017

(54) MATCHING METHOD AND MATCHING SYSTEM FOR USERS IN GAME

(71) Applicant: COLOPL, Inc., Tokyo (JP)

(72) Inventor: Takeshi KADA, Chiba (JP)

(21) Appl. No.: 15/448,509

(22) Filed: Mar. 2, 2017

(30) Foreign Application Priority Data
Mar. 3, 2016 (JP) 2016-041031

(51) Int. Cl. A63F 13/795; A63F 13/35

(52) U.S. Cl. CPC A63F 13/795; A63F 13/35

(57) ABSTRACT

A matching method includes receiving information on each of a plurality of users for a game. The information includes information on a skill level of each of the plurality of users and information on a terminal device to be used by each of the plurality of users. The terminal device includes a hardware device of the terminal device and a head mounted display (HMD) device. The matching method further includes selecting, from the plurality of users, a player candidate for a specific user based on the information on the skill level for each of the plurality of users and the information on the terminal device for each of the plurality of users.

### RELATED APPLICATIONS

The present application claims priority to Japanese Application Number 2016-041031, filed Mar. 3, 2016, the disclosure of which is hereby incorporated by reference herein in its entirety.

### BACKGROUND

This disclosure relates to a matching method and a matching system for matching a user with another user in a game.

In a competitive game, for example, user matching amongst a plurality of users who are to play together, namely, matching a user with another user who is an opponent the user is to play against, is performed based on a skill level of each of the plurality of users, in some instances. This allows users having a comparatively close skill level to enjoy the game by playing against each other.

However, in an online game, game progression, for example, a battle between users, is influenced by a game environment, for example, a terminal device being used by the user. Differences in the game environment being used can have an effect on game progression by the users. Therefore, user matching based only on the skill level of the users is inadequate, in some instances.

### SUMMARY

This disclosure has been created in view of the above-mentioned points, and this disclosure helps to provide a matching method and a matching system capable of performing user matching in an online game based on multiple factors, and a computer system for implementing such a matching method.

In order to help solve the above-mentioned problem, according to at least one aspect of this disclosure, there is provided a matching method for selecting, in an online game, a player candidate, with which a specific user among a plurality of users is to play, from other users among the plurality of users. The matching method includes receiving information on each of the plurality of users, the information includes information on a skill level of each of the plurality of users and information on a terminal device to be used by each of the plurality of users. The terminal device includes a hardware device of the terminal device and a head mounted display (HMD) device to be used together with the hardware device. The method further includes selecting, based on the information on the skill level of each of the plurality of users and the information on the terminal device of each of the plurality of users, a player candidate from the plurality of users for a specific user.

Further, according to at least one aspect of this disclosure, there is provided a computer system for executing the above-mentioned matching method.

Further, according to at least one aspect of this disclosure, there is provided a matching system for selecting, in an online game, a player candidate, with which a specific user among a plurality of users is to play, from among the plurality of users. The matching system includes user information storage means for storing information on each of the plurality of users. The information includes information on a skill level of each of the plurality of users and information on a terminal device to be used by each of the plurality of users. The terminal device includes a hardware device of the terminal device and a head mounted display (HMD) device to be used together with the hardware device. The matching system further includes player candidate selection means for selecting the player candidate for the specific user based on the information on the skill level of each of the plurality of users and the information on the terminal device of each of the plurality of users.

According to at least one embodiment of this disclosure, matching can be performed not only based on the skill level of each user, but also based on information relating to the terminal device of each user, which enables users having a comparatively close game playing ability, which is a measure of the overall ability of a player to progress through the game, to play together or to play against another player.

### BRIEF DESCRIPTION OF THE DRAWINGS

FIG. 1 is a hardware configuration diagram of a matching system according to at least one embodiment of this disclosure.

FIG. 2 is a block diagram for illustrating a functional configuration of the matching system according to at least one embodiment of this disclosure.

FIG. 3 is a flowchart of a method of operation of a matching system according to at least one embodiment of this disclosure.

FIG. 4 is a diagram an example of user information stored in a user information storage unit according to at least one embodiment of this disclosure.

FIG. 5 is a table of a device coefficient A determined based on a large category according to at least one embodiment of this disclosure.

FIG. 6 is a table of a device coefficient B determined based on a small category according to at least one embodiment of this disclosure.

FIG. 7 is a table of a device coefficient C determined based on an HMD device category according to at least one embodiment of this disclosure.

FIG. 8A is a table of a calculation example of matching evaluation values for an example using the user information illustrated in FIG. 4 and terminal device information according to at least one embodiment of this disclosure.

FIG. 8B is a table of a calculation example of matching evaluation table including calculation elements for matching evaluation when matching users 2 to 5 with a user 1 based on the information in FIG. 8A according to at least one embodiment of this disclosure.

FIG. 9A is a table of a calculation example of matching evaluation values for showing the user information on each user and terminal device classification for each user according to at least one embodiment of this disclosure.

FIG. 9B is a table of a calculation example of matching evaluation table including calculation elements for matching evaluation according to at least one embodiment of this disclosure.

FIG. 10A is a table of a calculation example of matching evaluation values for showing the user information on each user and terminal device classification for each user according to at least one embodiment of this disclosure.

FIG. 10B is a table of a calculation example of matching evaluation table including calculation elements for matching evaluation according to at least one embodiment of this disclosure.

### DETAILED DESCRIPTION

First, contents of at least one embodiment of this disclosure are listed and described. At least one embodiment of this disclosure has the following configuration.

(Item 1)

A matching method for selecting, in an online game, a player candidate with which a specific user among a plurality of users is to play. The matching method includes receiving information on each of the plurality of users. The information includes information on a skill level of each of the plurality of users and information on a terminal device to be used by each of the plurality of users. The terminal device includes a hardware device of the terminal device and a head mounted display (HMD) device to be used together with the hardware device. The method further includes selecting the player candidate for the specific user based on the information on the skill level of each of the plurality of users and the information on the terminal device of each of the plurality of users.

(Item 2)

A matching method according to Item 1, in which selecting the player candidate includes calculating a matching evaluation value for each of the plurality of users for the specific user based on the information on the skill level for each of the plurality of users and the information on the terminal device for each of the plurality of user. The matching evaluation value is calculated by using skill points represented by the information on the skill level for each of the plurality of users; and a device coefficient based on the information on the terminal device for each of the plurality of users.

(Item 3)

A matching method according to Item 2, in which selecting the player candidate includes classifying the terminal device of each of the plurality of users into a first category, a second category, and a third category based on the information on the terminal device. The first category relates to whether the hardware device of the terminal device is a console-type device or a mobile-type device. The second category relates to whether the hardware device is a PC device, a game device, or a mobile device. The third category relates to a type of the HMD device to be used together with the hardware device.

(Item 4)

A matching method according to Item 3, in which selecting the player candidate further includes providing the device coefficient relating to a relation between the type of the terminal device of each of the plurality of users and the type of the terminal device of the specific user. The device coefficient includes a first device coefficient for a device in the first category with respect to another device in the first category. The device coefficient further includes a second device coefficient for a device in the second category with respect to another device in the second category. The device coefficient further includes a third device coefficient for an HMD device in the third category with respect to another HMD device in the third category.

(Item 5)

A matching method according to Item 4, in which selecting the player candidate further includes calculating for the specific user the matching evaluation value of a first user among the plurality of users. The matching evaluation value includes an absolute value of a difference between the skill points of the specific user and the skill points of the first user. The matching evaluation value further includes the first device coefficient of the device of the first user with respect to the device of the specific user. The matching evaluation value further includes the second device coefficient of the device of the first user with respect to the device of the specific user. The matching evaluation value further includes the third device coefficient of the device of the first user with respect to the device of the specific user.

(Item 6)

A matching method according to Item 5, in which the matching evaluation value is calculated by multiplying the absolute value of the difference by each of the first device coefficient, the second device coefficient, and the third device coefficient.

(Item 7)

A matching method according to Item 6, in which the matching evaluation value is calculated by adding, when the absolute value of the difference is greater than a threshold value, the first device coefficient, the second device coefficient, and the third device coefficient.

(Item 8)

A matching method according to any one of Items 2 to 7, in which selecting the player candidate further includes determining the first user of the plurality of users, who has a smallest matching evaluation value, to be the player candidate.

(Item 9)

A computer system for causing a computer to execute the matching method of any one of Items 1 to 8.

(Item 10)

A matching system for selecting, in a game, a player candidate, with which a specific user among a plurality of users is to play, from among the plurality of users. The matching system includes user information storage means for storing information on the plurality of users, the information including information on a skill level of each of the plurality of users and information on a terminal device to be used by each of the plurality of users. The terminal device includes a hardware device of the terminal device and a head mounted display (HMD) device to be used together with the hardware device. The matching system further includes player candidate selection means for selecting the player candidate from the plurality of users based on the information on the skill level of each of the plurality of users and the information on the terminal device of each of the plurality of users.

(Item 11)

A matching system according to Item 10, in which the player candidate selection means is configured to calculate a matching evaluation value for each of the plurality of users for the specific user based on the information on the skill level of each of the plurality of users and the information on the terminal device for each of the plurality of users. The matching evaluation value is calculated by using skill points represented by the information on the skill level; and a device coefficient based on the information on the terminal device. The device coefficient relates to a relationship among different types of the terminal device to be used by each of the plurality of users.

(Item 12)

A matching system according to Item 11, in which the player candidate selection means includes terminal device classifying means for classifying the terminal device of each of the plurality of users into a first category, a second category, and a third category based on the information on the terminal device for each of the plurality of users. The first category relates to whether the hardware device of the terminal device is a console-type device or a mobile-type device. The second category relates to whether the hardware device is a PC device, a game device, or a mobile device. The third category relates to a type of the HMD device to be used together with the hardware device.

(Item 13)

A matching system according to Item 12, in which the player candidate selection means further includes device coefficient storage means for storing the device coefficient relating to a relation between the type of the terminal device of each of the plurality of users and the type of the terminal device of the specific user. The device coefficient includes a first device coefficient for a device in the first category with respect to another device in the first category. The device coefficient includes a second device coefficient for a device in the second category with respect to another device in the second category. The device coefficient includes a third device coefficient for an HMD device in the third category with respect to another HMD device in the third category.

(Item 14)

A matching system according to Item 13, in which the player candidate selection means further includes matching evaluation value calculation means for calculating for the specific user the matching evaluation value of a first user among the plurality of users. The matching evaluation value includes an absolute value of a difference between the skill points of the specific user and the skill points of the first user. The matching evaluation value further includes a first device coefficient of the device of the first user with respect to the device of the specific user. The matching evaluation value further includes a second device coefficient of the device of the first user with respect to the device of the specific use. The matching evaluation value further includes a third device coefficient of the device of the first user with respect to the device of the specific user.

(Item 15)

A matching system according to Item 14, in which the matching evaluation value is calculated by multiplying the absolute value of the difference by each of the first device coefficient, the second device coefficient, and the third device coefficient.

(Item 16)

A matching system according to Item 15, in which the matching evaluation value is calculated by adding, when the absolute value of the difference is zero, the first device coefficient, the second device coefficient, and the third device coefficient.

(Item 17)

A matching system according to any one of Items 10 to 16, in which the player candidate selection means further includes candidate determination means for determining the first user, who has a smallest matching evaluation value, to be the player candidate.

(Item 18)

A computer system for causing a computer to function as the matching system of any one of Items 10 to 17.

At least one embodiment of this disclosure is now described in detail with reference to the drawings.

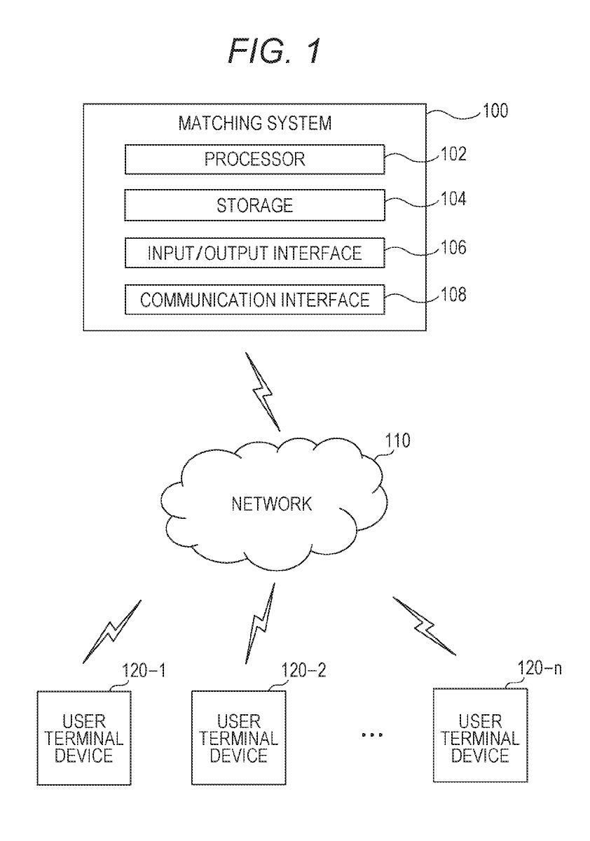

FIG. 1 is a hardware configuration diagram of a matching system 100 for a game according to at least one embodiment of this disclosure. The matching system 100 includes at least a processor 102, a storage 104, an input/output interface (IF) 106, and a communication interface (IF) 108, which are electrically connected to each other by a communication bus (not shown). The matching system 100 can be implemented by a work station, a personal computer (PC), and as a server such as a game server configured to provide various types of services relating to a game, for example. The storage 104 is configured to store at least an operating system, a matching program, and various types of data to be used in matching, or a database configured to store the operating system, the matching program, and the various types of data to be used in matching. The operating system is a computer system for controlling the operation of the matching system 100. The matching program is a computer program for the matching system. 100 to achieve respective functions of matching to be described later. The storage 104 can further temporarily or permanently store data generated by the operation of the matching system 100. Specific examples of the storage 104 include a read only memory (ROM), a random access memory (RAM), a hard disk, a flash memory, and an optical disc.

The processor 102 is configured to read out a program stored in the storage 104, to thereby execute processing in accordance with the program. When the processor 102 executes the matching program stored in the storage 104, various functions of the matching system to be described later are achieved. The processor 102 is, for example, a central processing unit (CPU).

The input/output IF 106 is configured to, for example, receive inputs for managing the matching system 100 from an operator of the matching system 100, and to generate outputs, for example, a display to the operator. Specific examples of the input/output IF 106 include a keyboard, a touchpad, a mouse, a display, and a printer.

The communication IF 108 is a network interface for communicating to and from multiple user terminal devices 120-1 to 120-n, collectively referred to a terminal device 120, via a network 110. For example, the matching system 100 is capable of transmitting and receiving the various types of data to be used in matching to and from the various types of user terminal devices connected to the network 110 through use of the communication IF 108. The network 110 may be, for example, the Internet, various types of mobile communication systems (for example, so-called 3G or 4G mobile communication system, or long term evolution (LTE)) constructed from wireless base stations (not shown), or a wireless network (for example, Wi-Fi®) capable of connecting to the Internet via a predetermined access point.

The user terminal devices 120-1 to 120-n may be, for example, a personal computer (PC), a tablet computer, a game device, and a mobile device (for example, a smartphone, a feature phone, or a personal digital assistant (PDA)). Although not shown in the drawings, each user terminal device 120 includes a processor, a memory, a storage, a communication interface (IF), and an input/output interface (IF), which are electrically connected to each other by a communication bus. Each user terminal device 120 also includes an output device, for example, a head mounted display (HMD) device (hereinafter referred to as “HMD device”). Each user terminal device 120 may further include a touch panel or another type of input device.

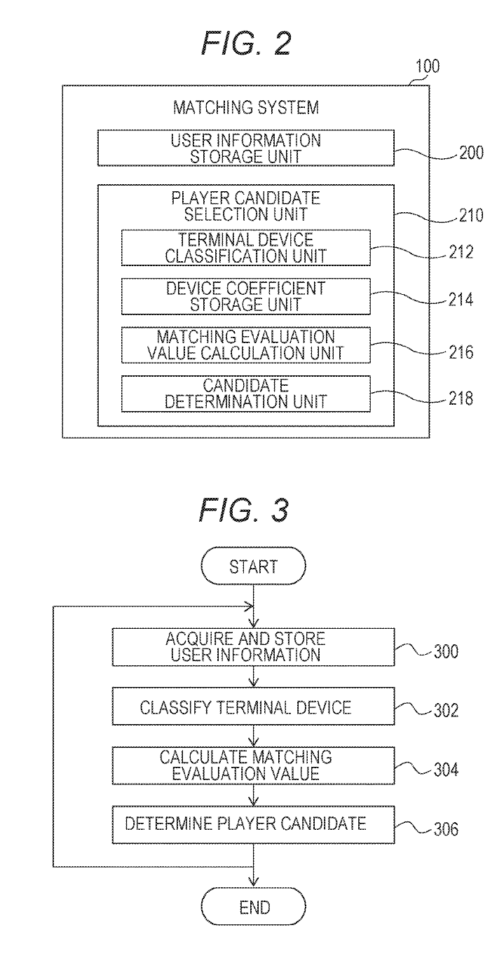

FIG. 2 is a block diagram of a functional configuration of the matching system 100. The matching system 100 in FIG. 2 is implemented by a computer program executed by the computer hardware of FIG. 1. The matching system 100 includes, as illustrated in FIG. 2, a user information storage unit 200 and a player candidate selection unit 210. The player candidate selection unit 210 includes a terminal device classification unit 212, a device coefficient storage unit 214, a matching evaluation value calculation unit 216, and a candidate determination unit 218.

Next, operation of the matching system 100 illustrated in FIG. 2 is described in detail with reference to FIG. 3. First, in Step 300, the user information storage unit 200 acquires and stores user information on a user wanting to play the game. The user information includes skill points indicating the skill level of the user in the game and information on the terminal device 120 to be used by the user. The information on the terminal device 120 includes information on a hardware (HW) device of the terminal device 120 and information on the HMD device to be used in association with that hardware device. The user information may be acquired by extracting information on the user from an existing database relating to the game, or by prompting the user to directly input the user information.

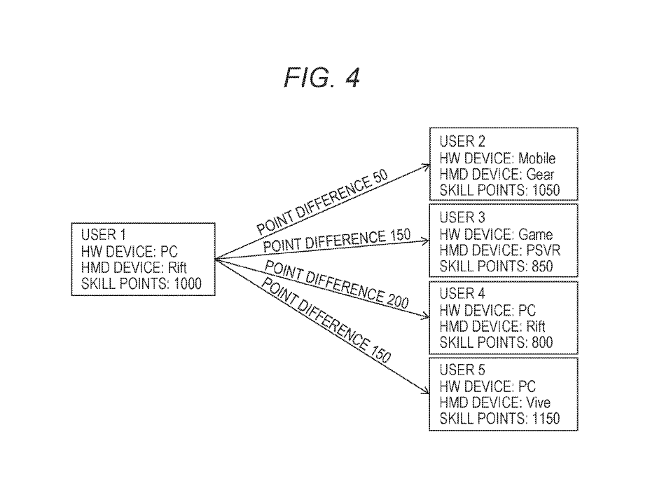

In FIG. 4, there is illustrated an example of the user information acquired and stored by the user information storage unit 200. In the example, in a game that five users, namely, users 1 to 5, want to play, a specific user among those users, namely, a user 1, is matched with another of the users 2 to 5 as a player that the specific user is to play with. Specifically, the user information includes a user identification, an HW device type, an HMD device type, and skill points. In the illustrated example, the user 1 has PC as his/her HW device, Rift as his/her HMD device, and 1,000 skill points. The user 2 has Mobile as his/her HW device, Gear as his/her HMD device, and 1,050 skill points. The user 3 has Game as his/her HW device, PSVR as his/her HMD device, and 850 skill points. The user 4 has PC as his/her HW device, Rift as his/her HMD device, and 800 skill points. The user 5 has PC as his/her HW device, Vive as his/her HMD device, and 1,150 skill points.

In FIG. 4, there are three types of HW device, namely, PC, Game (game device), and Mobile (mobile device), but there may be more types of HW device or fewer types of HW device. As the HMD device, the example includes the four types that are currently available, namely, Rift, Gear, PSVR, and Vive, but devices other than those four may be added.

In FIG. 4, there are five users, but matching may be performed between more users or fewer users. Further, one user is selected as a player candidate in the example in FIG. 4, but two or more users may be selected as player candidates for a game to be played together by three or more people.

Next, in Step 302, based on the information on each terminal device 120, the terminal device classification unit 212 classifies the terminal device of each user into at least three categories, namely, a large category, a small category, and an HMD device category. The large category and the small category relate to the processing capability of the HW device of the terminal device 120 of the user. Specifically, in the large category, the HW device of the terminal device is classified as a console-type or a mobile-type. A mobile-type device in the large category includes a mobile-type device which is sufficiently large that a user could not carry the mobile-type device while playing the game. Terminal devices classified as being a console-type have a higher processing capability than mobile-type terminal devices. Examples of console-type terminal devices may include desktop computers and console-type game devices. In contrast, terminal devices classified as being a mobile-type have a lower processing capability than console-type terminal devices. Examples of mobile-type terminal devices may include notebook computers, laptop computers, tablet computers, mobile-type game devices, and smartphones. The terminal devices mentioned above are merely examples, and the classification of whether a terminal device is a console-type or a mobile-type may be performed in more detail in accordance with the actual processing capability of the terminal device. In at least one embodiment, terminal device classification unit 212 classifies the terminal device 120 of each of the user based on a processing speed of the terminal device 120 regardless of the structure of the terminal device 120.

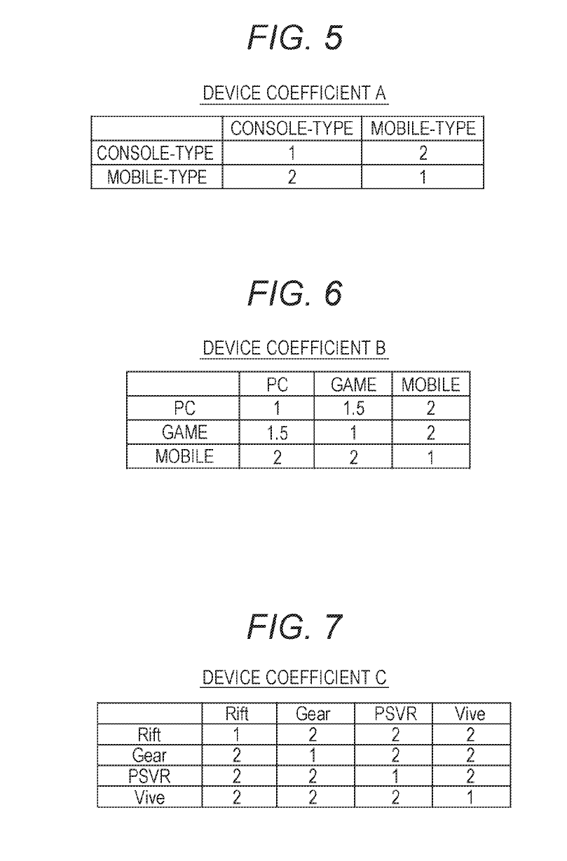

FIG. 5 is a table for a device coefficient A determined based on the large category. The table is used to calculate a matching evaluation value, which is described later, and hence is stored in the device coefficient storage unit 214 of FIG. 2. As shown in FIG. 5, when the terminal device of each of the two users to be matched is the same type (i.e., console-type or mobile-type), the device coefficient A is 1, and when the terminal devices are different types, the device coefficient A is 2. The reason why the coefficient is set higher when the terminal devices are different types than when the terminal devices are the same type is because the difference in game playability increases when the terminal devices are different types. Therefore, for example, for the same skill point difference, the device coefficient A when the terminal devices are different types acts in the direction causing the matching in the matching evaluation to become more unbalanced. The above-mentioned coefficient values are examples determined in order to reflect the difference in processing capabilities between console-type and mobile-type HW devices in more detail, but other values may also be assigned. In at least one embodiment, as a processing ability of the terminal device 120 increases the value for device coefficient A also increases.

The small category, which is used in combination with the large category, is for providing a more detailed classification in accordance with the difference in processing capability of the terminal devices 120. Specifically, each terminal device is classified as a PC, a game device, or a mobile device. This enables the classification based on the large category to be supplemented.

FIG. 6 is a table for a device coefficient B determined based on the small category. The table is used to calculate the matching evaluation value, which is described later, and hence is stored in the device coefficient storage unit 214. As shown in FIG. 6, when the terminal device of each of the two users to be matched is the same type (i.e., PC, game device, or mobile device), the device coefficient is 1, and when the terminal devices are different types, that is, the PC and the game device, the device coefficient B is 1.5. When the terminal devices are the PC or the game device and the mobile device, the device coefficient B is 2. The reason why the coefficient is set higher between a PC and a mobile device (device coefficient B=2) than between a PC and a game device (device coefficient B=1.5) is because the difference in game playability is larger between a PC and a mobile device. However, the coefficient between a PC and a mobile device (device coefficient B=2) and the coefficient between a game device and a mobile device (device coefficient B=2) are set to the same value because the processing capability of a game device is much closer to the processing capability of a PC than the processing capability of a mobile device. As a result, for example, for users having the same skill points, the device coefficient B acts in the direction causing the matching in the matching evaluation to become more unbalanced for a mobile device than for a game device, as compared with a PC, for example. Those coefficient values are examples determined in order to reflect the difference in processing capabilities among a PC, a game device, and a mobile device in more detail, but similar to the device coefficient A, other values may also be assigned.

The HMD device category is used to classify the HMD device in accordance with the processing capability of the HMD device. There are currently a plurality of devices, such as Rift, Gear, PSVR, and Vive, that are available as HMD devices to be used for virtual reality (VR) games, and those device are used as classification examples. Other HMD devices may also be included in the classifications. In the HMD device category, there is a large influence on game playability when the HMD devices are different. Therefore, to the greatest extent possible, users using the same HMD device are matched in order to reduce any positive or negative effects resulting from differences in the used HMD devices. Even when the HMD devices are the same, differences in model number or version can have an effect on game playability. In such a case, classification may be performed by also using the model number and the version of the HMD device. Similar to the HW device, in addition to the device name of the HMD device, a plurality of classifications may also be provided for the HMD device category in accordance with the processing capability of the HMD device.

FIG. 7 is a table for showing a device coefficient C determined based on the HMD device category. This table is also used to calculate the matching evaluation value, which is described later, and hence is stored in the device coefficient storage unit 214. As shown in FIG. 7, when the HMD device of each of the two users to be matched is the same device (i.e., Rift, Gear, PSVR, or Vive), the device coefficient C is 1, and when the HMD devices are different, the device coefficient C is 2. Those coefficient values are examples determined in order to reflect the difference in processing capabilities among Rift, Gear, PSVR, and Vive, but similar to the device coefficients A and B, other values may also be assigned. In at least one embodiment, the model and/or version number of the HMD device also help to determine a value of the device coefficient C.

In Step 304, the matching evaluation value calculation unit 216 calculates the matching evaluation value of another user for a specific user who wants to play the game. The matching evaluation value is an index for evaluating a degree of matching when a given user is matched with the other user. The index enables a difference in game playing ability between the matched users to be evaluated. Therefore, a user having a smaller matching evaluation value is more likely to become a player candidate as an opponent or a teammate, for example, because there is a smaller difference in game playing ability with the specific user.

More specifically, the matching evaluation value calculation unit 216 is configured to calculate the matching evaluation value through use of the following matching evaluation Expression 1 based on the user information received in Step 300 and the terminal device classification classified in Step 302.

Matching evaluation value=Skill point difference×Device coefficient A×Device coefficient B×Device coefficient C (1)

In Expression 1, the skill point difference is the absolute value of the difference in skill points.

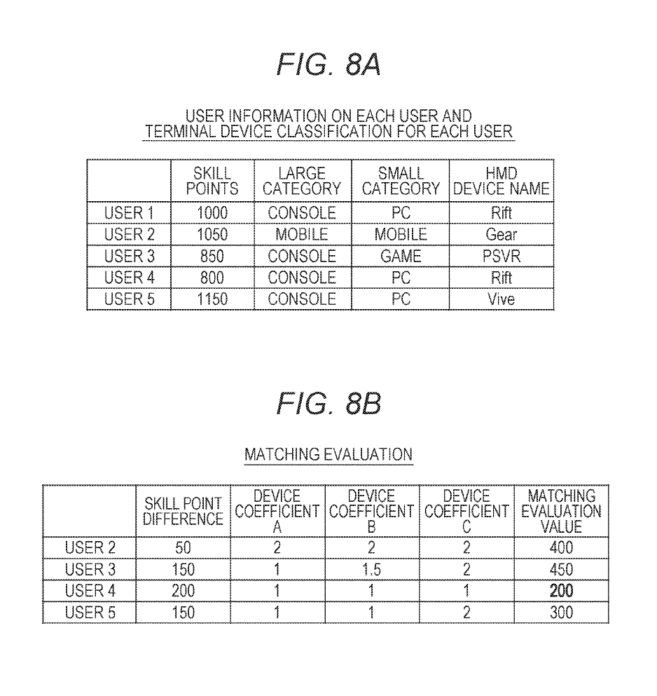

A calculation example of the matching evaluation values is now described with reference to FIG. 8A and FIG. 8B. FIG. 8A is a table for showing the user information illustrated in FIG. 4 and terminal device information. FIG. 8B is a table for showing the calculation elements for the matching evaluation and the matching evaluation values, which are results obtained using those calculation elements. In FIG. 8B, there is shown a calculation example of the matching evaluation values when the users 2 to 5 are matched with the user 1 based on the information shown in FIG. 8A. More specifically, in FIG. 8B, for example, in the case of the user 2, the difference between the skill points of the user 2 (=1,050) and the skill points of the user 1 (=1,000) is 50 points. Regarding the device coefficient A, the large category for the user 1 is console-type, whereas the large category for the user 2 is mobile-type. Therefore, based on the table of FIG. 5, the device coefficient A is 2. Regarding the device coefficient B, the small category for the user 1 is PC, whereas the small category for the user 2 is mobile. Therefore, based on the table of FIG. 6, the device coefficient B is 2. Regarding the device coefficient C, the HMD device name for the user 1 is Rift, whereas the HMD device name for the user 2 is Gear. Therefore, based on the table of FIG. 7, the device coefficient C is 2. In this case, the matching evaluation value is, in accordance with Expression 1, 50×2×2×2=400. For the remaining users 3 to 5 as well, the skill point differences and the device coefficients A, B, and C are similarly determined, and the matching evaluation values thereof are calculated. As a result, the matching evaluation values for the users 3 to 5 are respectively 450, 200, and 300.

In Expression 1, when the skill point difference is zero, the matching evaluation value is zero. Therefore, when there are users having the same skill points, the matching evaluation value is calculated based on the following Expression 2.

Matching evaluation value=Device coefficient A+Device coefficient B+Device coefficient C (2)

More specifically, the sum of the device coefficients A, B, and C is taken as the matching evaluation value.

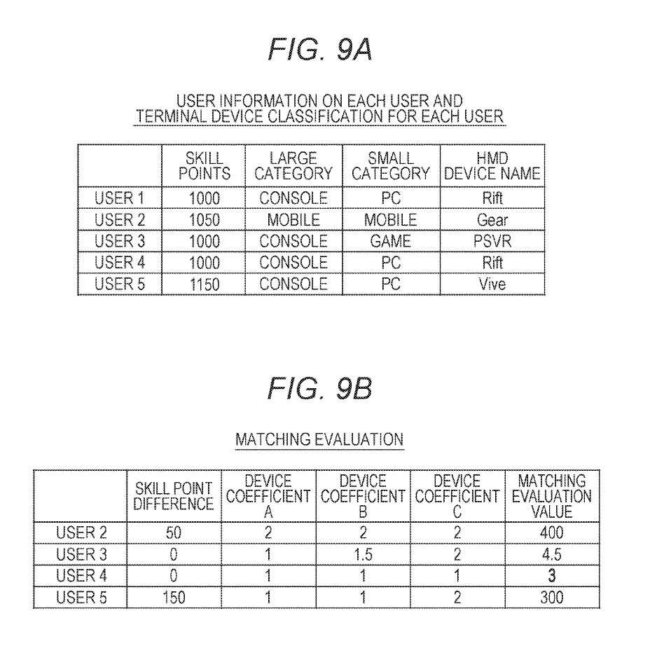

Similarly to FIG. 8A and FIG. 8B, FIG. 9A is a table for showing the user information on each user and the terminal device classification for each user, and FIG. 9B is a table for showing the calculation elements for the matching evaluation and the matching evaluation values, which are results obtained using those calculation elements. The difference from FIG. 8A and FIG. 8B is that, as shown in FIG. 9A, the users 3 and 4 have 1,000 skill points, which is the same as that of the user 1, and therefore in FIG. 9B, the users 3 and 4 have a skill point difference of zero. In this case, the matching evaluation values calculated in accordance with Expression 2 are respectively 4.5 and 3. In this way, the index of the degree of matching when matching the user 1 with another user is calculated.

Next, in Step 306, the candidate determination unit 218 determines a player candidate for a specific user based on the matching evaluation values calculated in Step 304. Specifically, the user having the smallest calculated matching evaluation value is selected as the player candidate. As shown in the example of FIG. 8B, among the matching evaluation values of the users 2 to 5, the user 4 has the smallest value of 200, and hence the user 4 is selected as the player candidate. In contrast, in the examples shown in FIG. 9A and FIG. 9B, the user 4 has the smallest matching evaluation value of 3, and hence the user 4 is selected as the player candidate.

As at least one embodiment for calculating the matching evaluation value, the following Expression 3 may also be used.

Matching evaluation value={1+(Skill point difference/Reference skill points)}×Device coefficient A×Device coefficient B×Device coefficient C (3)

In Expression 3, the reference skill points are the skill points of the user serving as a reference for comparison. In the above-mentioned example, the reference skill points are the skill points of the user 1. Using Expression 3 allows the matching evaluation value to avoid becoming zero when the skill points of the users are the same.

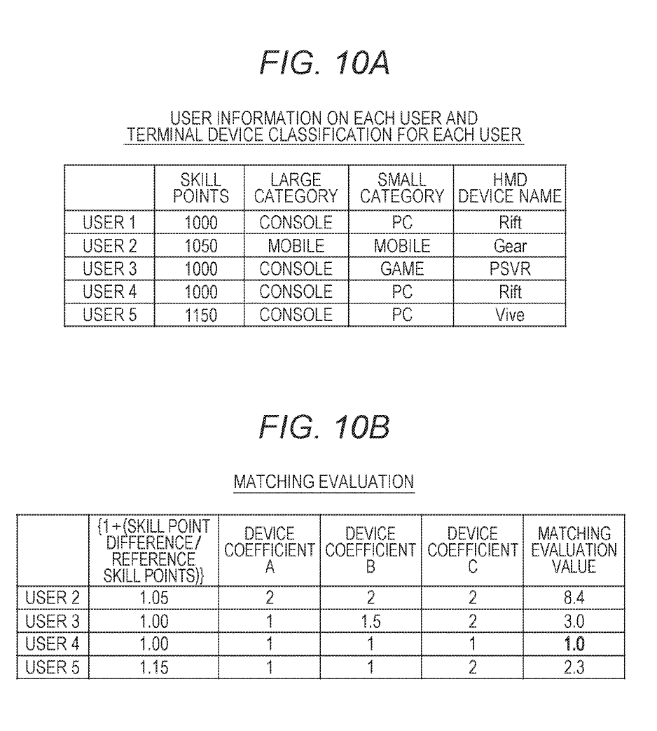

In FIGS. 10A and 10B, the same coefficient values are used as those used in FIG. 9A and FIG. 9B. In comparison with FIGS. 9A and 9B, FIGS. 10A and 10B are an example when Expression 3 is used. In FIG. 10B, the matching evaluation values calculated in accordance with Expression 3 are shown. As shown in FIG. 10A and FIG. 10B, the user 4 has the smallest matching evaluation value of 1.0, and hence the user 4 is selected as the player candidate.

In the player candidate selection described above, when only one player candidate is to be selected, that player candidate is determined to be the opponent or teammate to play with the user. However, when two or more users are to be selected as player candidates, those users may be presented such that the user 1 can select one of them. In that case, a plurality of users from among the users having the smallest matching evaluation values are selected as the player candidates, and the selected player candidates are transmitted to the user terminal device of the user 1 such that those player candidates are selectable. The user 1 selects one user from among the received plurality of player candidates, and that selection result is transmitted to the matching system 100. The matching system 100 responds to the transmitted selection result, and the selected player candidate may be determined to be the opponent, for example, of the user 1.

In this way, in a game that a given user wants to play, the matching system 100 is capable of selecting, as the player to play with the given user, the user having a game playing ability that is as close as possible to the user. As a result, passionate game play can be enjoyed without either user one-sidedly winning or losing.

In at least one embodiment, the three categories, namely, the large category, the small category, and the HMD device category, are used for classification of the user terminal device. However, in at least one embodiment at least one category among those three categories is omitted, or more than three categories are used by adding a different category, for example. Even when at least one category among the above-mentioned three categories is omitted, better user matching can be implemented than when only the skill level of the users is used for matching.

While a description of the matching system has been given above in accordance with at least one embodiment of this disclosure, this disclosure is not limited thereto, and various modifications can be made without departing from the spirit of this disclosure.

What is claimed is:

1. A matching method comprises:
receiving information on each of a plurality of users for a game, wherein the information comprising information on a skill level of each of the plurality of users and information on a terminal device to be used by each of the plurality of users, the terminal device comprising a hardware device of the terminal device and a head mounted display (HMD) device; and
selecting, from the plurality of users, a player candidate for a specific user based on the information on the skill level for each of the plurality of users and the information on the terminal device for each of the plurality of users.

2. The matching method according to claim 1,
wherein selecting the player candidate comprises calculating a matching evaluation value for each of the plurality of users for the specific user based on the information on the skill level for each of the plurality of users and the information on the terminal device for each of the plurality of users, and
wherein the matching evaluation value is calculated by using:
skill points based on the information on the skill level; and
a device coefficient based on the information on the terminal device and relating to a relation among different types of the terminal devices to be used by each of the plurality of users.

3. The matching method according to claim 2,
wherein selecting the player candidate comprises classifying the terminal device of each of the plurality of users into a first category, a second category, and a third category based on the information on the terminal device for each of the plurality of users,
wherein the first category relates to whether the hardware device of the terminal device is a console-type device or a mobile-type device,
wherein the second category relates to whether the hardware device is a personal computer (PC) device, a game console device, or a mobile device, and
wherein the third category relates to a type of the HMD device.

4. The matching method according to claim 3,
wherein selecting the player candidate further comprises providing the device coefficient relating to a relation between the type of the terminal device of each of the plurality of users and the type of the terminal device of the specific user, and
wherein the device coefficient comprises:
a first device coefficient for a device in the first category with respect to another device in the first category;
a second device coefficient for a device in the second category with respect to another device in the second category; and
a third device coefficient for a HMD device in the third category with respect to another HMD device in the third category.

5. The matching method according to claim 4,
wherein selecting the player candidate further comprises calculating for the specific user the matching evaluation value of at least a first user among the plurality of users, and
wherein the matching evaluation value comprises:
an absolute value of a difference between the skill points of the specific user and the skill points of the first user;
the first device coefficient of the hardware device of the first user with respect to the hardware device of the specific user;
the second device coefficient of the hardware device of the first user with respect to the hardware device of the specific user; and
the third device coefficient of the HMD device of the first user with respect to the HMD device of the specific user.

6. The matching method according to claim 5, wherein the matching evaluation value is calculated by multiplying the absolute value of the difference by each of the first device coefficient, the second device coefficient, and the third device coefficient.

7. The matching method according to claim 6, wherein the matching evaluation value is calculated by adding the first device coefficient, the second device coefficient, and the third device coefficient.

8. The matching method according to claim 2, wherein selecting the player candidate further comprises determining a user of the plurality of users who has a smallest matching evaluation value to be the player candidate.

9. A non-transitory computer readable medium configured to store instructions, wherein a process is configured to execute the instructions for causing a computer to:
retrieve information on each of a plurality of users for a game, wherein the information comprising information on a skill level of each of the plurality of users and information on a terminal device to be used by each of the plurality of users, the terminal device comprising a hardware device of the terminal device and a head mounted display (HMD) device; and
select, from the plurality of users, a player candidate for a specific user based on the information on the skill level for each of the plurality of users and the information on the terminal device for each of the plurality of users.

10. A matching system comprising:
a non-transitory computer readable medium configured to store instructions; and
a processor connected to the non-transitory computer readable medium, wherein the processor is configured to execute the instructions to function as:
a user information storage means for storing information on a plurality of users for a game, the information comprising information on a skill level of each of the plurality of users and information on a terminal device to be used by each of the plurality of users, the terminal device comprising a hardware device of the terminal device and a head mounted display (HMD) device to be used together with the hardware device; and
a player candidate selection means for selecting from the plurality of users a player candidate for a specific user based on the information on the skill level of each of the plurality of users and the information on the terminal device for each of the plurality of users.

11. The matching system according to claim 10,
wherein the player candidate selection means is configured to calculate a matching evaluation value of each of the plurality of users for the specific user based on the information on the skill level of each of the plurality of users and the information on the terminal device for each of the plurality of users, and
wherein the matching evaluation value is calculated based on:
skill points corresponding to the information on the skill level; and
a device coefficient based on the information on the terminal device and relating to a relation among different types of the terminal device to be used by each of the plurality of users.

12. The matching system according to claim 11,
wherein the processor is further configured to function as: a terminal device classifying means for classifying the terminal device of each of the plurality of users into a first category, a second category, and a third category based on the information on the terminal device,
wherein the first category relates to whether the hardware device of the terminal device is a console-type device or a mobile-type device,
wherein the second category relates to whether the hardware device is a PC device, a game device, or a mobile device, and
wherein the third category relates to a type of the HMD device.

13. The matching system according to claim 12,
wherein the non-transitory computer readable medium is configured to function as a device coefficient storage means for storing the device coefficient relating to a relation between the type of the terminal device of each of the plurality of users and the type of the terminal device of the specific user, and
wherein the device coefficient comprises:
a first device coefficient for a device in the first category with respect to another device in the first category;
a second device coefficient for a device in the second category with respect to another device in the second category; and
a third device coefficient for a HMD device in the third category with respect to another HMD device in the third category.

14. The matching system according to claim 13,
wherein the processor is further configured to function as a matching evaluation value calculating means for calculating for the specific user the matching evaluation value of at least a first user among the plurality of users, and
wherein the matching evaluation value comprises:
an absolute value of a difference between the skill points of the specific user and the skill points of the first user;
the first device coefficient of the hardware device of the first user with respect to the hardware device of the specific user;
the second device coefficient of the hardware device of the first user with respect to the hardware device of the specific user; and
the third device coefficient of the HMD device of the first user with respect to the HMD device of the specific user.

15. The matching system according to claim 14, wherein the processor is configured to calculate the matching evaluation value by multiplying the absolute value of the difference by each of the first device coefficient, the second device coefficient, and the third device coefficient.

16. The matching system according to claim 15, wherein the processor is configured to calculate the matching evaluation value by adding the first device coefficient, the second device coefficient, and the third device coefficient.

17. The matching system according to claim 10, wherein the processor is further configured to function as a candidate determining means for determining a user of the plurality of users, who has a smallest matching evaluation value, to be the player candidate.

18. The matching system according to claim 10, wherein the processor is configured to selected a plurality of player candidates.

19. The matching system according to claim 18, wherein the processor is configured to prompt the specific user to select an opponent or a teammate from amongst the plurality of player candidates.
